(19) United States
(12) Patent Application Publication
(10) Pub. No.: US 2016/0351092 A1
(43) Pub. Date: Dec. 1, 2016

(54) DISPLAY PANEL AND REPAIRING METHOD THEREOF

(71) Applicant: AU Optronics Corp, Hsin-Chu (TW)

(72) Inventors: Chang-Chan Chen, Hsin-Chu (TW); Wen-Pin Hsu, Hsin-Chu (TW); Pin-Miao Liu, Hsin-Chu (TW)

(21) Appl. No.: 15/002,369

(22) Filed: Jan. 20, 2016

(30) Foreign Application Priority Data
Jun. 1, 2015 (TW) 104117576

(51) Int. Cl. G09G 3/00; G09G 3/32

(52) U.S. Cl. CPC G09G 3/006; G09G 3/32

(57) ABSTRACT

A method for repairing a display panel includes the following steps. A display panel is provided. The display panel includes a substrate and a plurality of pixel units. The pixel units are disposed on the substrate, wherein each pixel unit includes at least one bonding pad, at least one light-emitting device and at least one first substitutive bonding pad. The bonding pad is disposed on the substrate. The light-emitting unit is disposed on the bonding pad and is electrically connected to the bonding pad. The first substitutive bonding pad is disposed on the substrate. A defect detecting process is performed to detect whether the light-emitting device of each pixel unit is defective or not. A repairing process is performed to form a first substitutive light-emitting device on the first substitutive bonding pad when a light-emitting device of a pixel unit is found defective.

### BACKGROUND OF THE DISCLOSURE

1. Field of the Disclosure

The present disclosure relates to a display panel and repairing method thereof, and more particularly, to a display panel and repairing method thereof with substitutive bonding pads.

2. Background of the Disclosure

With the progress of optoelectronics and related technologies, electronic products, such as personal digital assistant (PDA), mobile phone, smart phone and notebook (NB) are getting popular. As the demands for those electronic products are increased, the display screen/panel, which plays an important role in those electronic products, has become the primary objective to designers in this field.

Due to its advantages such as environment friendly, high photoelectric conversion efficiency, compact size, long lifetime, controllable wavelength and low heat generation, light emitting diodes (LED) have been widely used in the display panel. For example, from the large display boards in the city to the traffic signs on the street, and from the switch indicators of the electronic products to the backlight of the screen, the LEDs certainly gradually replace the traditional light sources. Currently, the LED display panels are manufactured by separately producing each of the LEDs and then picking and placing each of the LEDs to each pixel unit of the substrate. When any one of the LEDs is damage or is loss during the manufacturing process, the pixel unit would not be able to emit light and therefore dark spots might be appeared on the LED display panel. However, display panels are difficult to rework and the manufacturing process of the display panels is complicated. As a result, it is desirable to establish an easy-to-rework and simplified process of the LED display panels.

### SUMMARY OF THE DISCLOSURE

In one aspect of the present disclosure, a repairing method of display panel is provided. In certain embodiments, the repairing method comprises the following steps. A display panel is provided, wherein the display panel comprises a substrate and a plurality of pixel units. The substrate has a plurality of pixel regions. The pixel units are disposed on the substrate and respectively located in the pixel regions, wherein each of the pixel units comprises at least one bonding pad, at least one light-emitting device and at least one first substitutive bonding pad. The at least one bonding pad is disposed on the substrate. The at least one light-emitting device is disposed on and electrically connected to the at least one bonding pad. The at least one first substitutive bonding pad is disposed on the substrate and electrically connected to the at least one bonding pad. A defect detecting process is performed to detect whether the light-emitting devices are defective or not. A repairing process is performed to form a first substitutive light-emitting device on the first substitutive bonding pad when a light-emitting device of a pixel unit is found defective.

In another aspect of the present disclosure, a display panel is provided. In certain embodiments, the display panel comprises a substrate and a plurality of pixel units. The substrate has a plurality of pixel regions. The pixel units are disposed on the substrate and respectively located in the pixel regions, wherein each of the pixel units comprises at least one bonding pad, at least one light-emitting device and at least one first substitutive bonding pad. The at least one bonding pad is disposed on the substrate. The at least one light-emitting device is disposed on and electrically connected to the at least one bonding pad. The at least one first substitutive bonding pad is disposed on the substrate and electrically connected to the at least one bonding pad.

In the display panel of the present disclosure, each pixel unit includes at least one substitutive bonding pad (or namely spare bonding pad, or backup bonding pad). When a light-emitting device of a pixel unit is detected and found defective, a substitutive light-emitting device is formed on the substitutive bonding pad of the same pixel unit. Consequently, each pixel unit includes at least one light-emitting device that can function normally and emit light of desired color.

These and other aspect of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are schematic diagram illustrating a method of fabricating a display panel according to a first embodiment of the present disclosure.

FIG. 3 is a top view diagram of the display panel according to the first embodiment the present disclosure.

FIG. 4 is an equivalent circuit diagram of the display panel according to the first embodiment of the present disclosure.

FIG. 5 is a flow chart illustrating a repairing method of display panel according to an embodiment of the present disclosure.

FIGS. 6-7 are schematic diagrams illustrating a repairing method of display panel according to the first embodiment of the present disclosure.

FIG. 8 is a top view diagram illustrating a repaired display panel according to the first embodiment of the present disclosure.

FIG. 9 is a flow chart illustrating a repairing method of display panel according to another embodiment of the present disclosure.

FIGS. 10-11 are schematic diagrams illustrating a repairing method of display panel according to an alternative embodiment of the first embodiment of the present disclosure.

FIG. 12 is a top view diagram illustrating a repaired display panel according to the alternative embodiment of the first embodiment of the present disclosure.

FIG. 13 is a top view diagram illustrating a display panel according to a second embodiment of the present disclosure.

FIGS. 14-16 are schematic diagrams illustrating a repairing method of display panel according to the second embodiment of the present disclosure.

FIG. 17 is a top view diagram illustrating a repaired display panel according to the second embodiment of the present disclosure.

FIG. 18 is a top view diagram illustrating a display panel according to a third embodiment of the present disclosure.

FIG. 19 is a top view diagram illustrating a repaired display panel according to the third embodiment of the present disclosure.

### DETAILED DESCRIPTION

To provide a better understanding of the present disclosure, preferred embodiments will be made in detail. The preferred embodiments of the present disclosure are illustrated in the accompanying drawings with numbered elements.

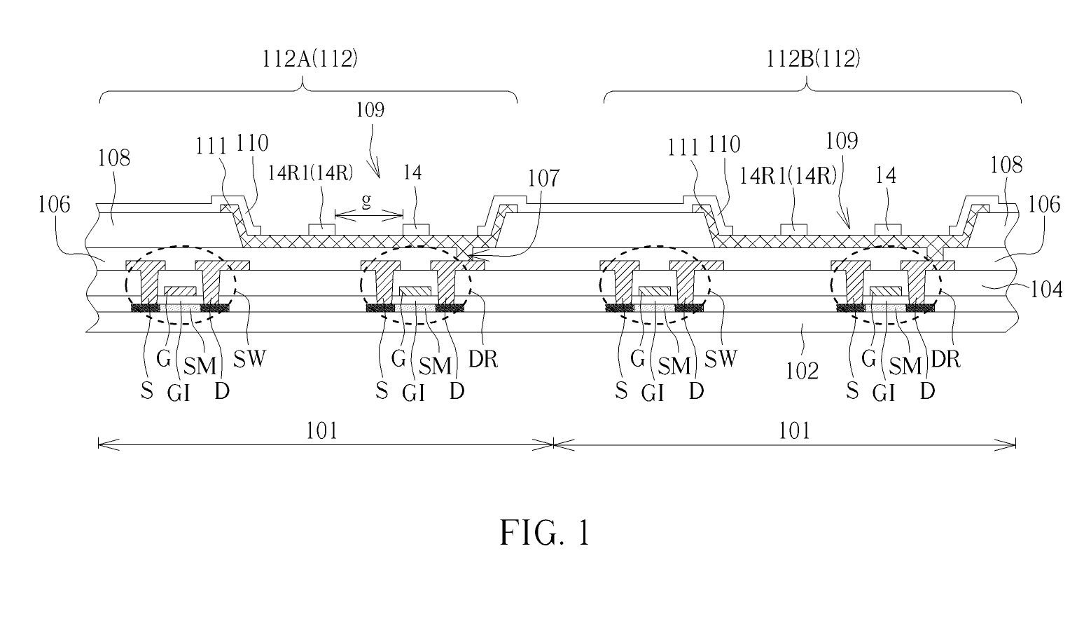

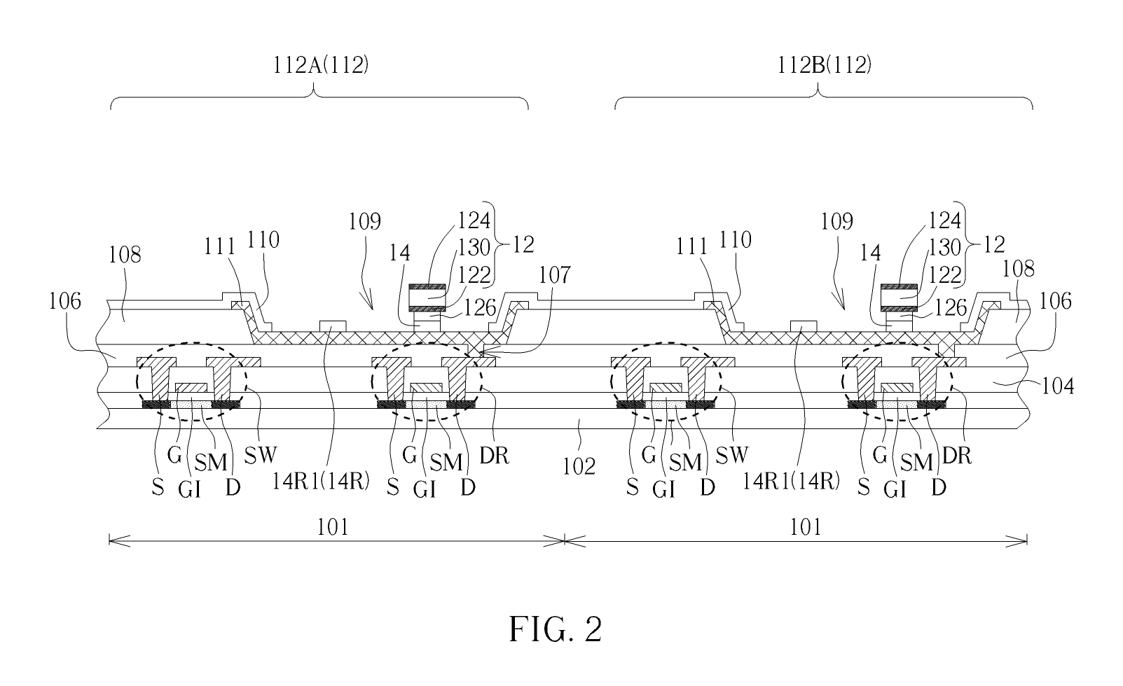

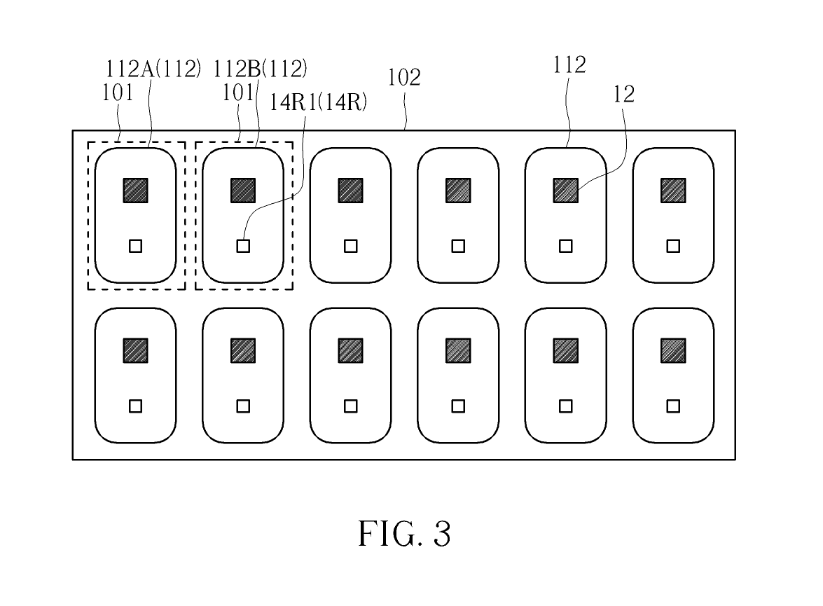

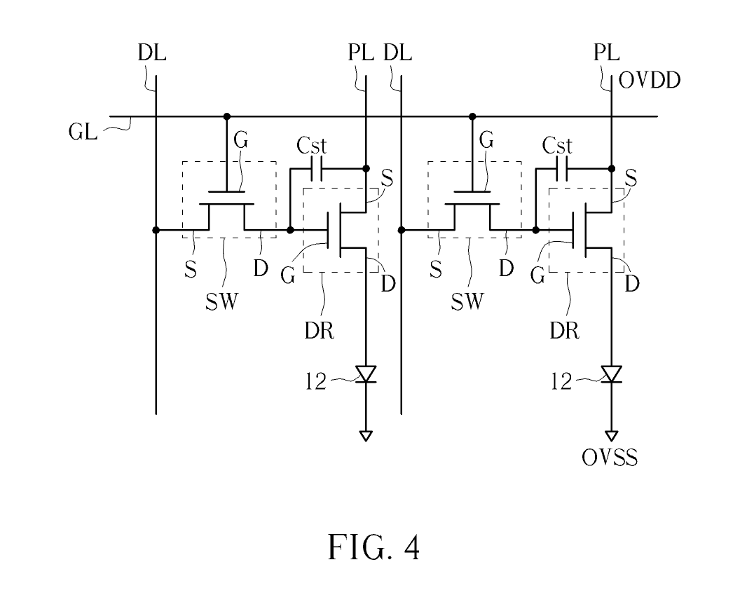

Refer to FIGS. 1-4. FIGS. 1-2 are schematic diagram illustrating a method of fabricating a display panel according to a first embodiment of the present disclosure, FIG. 3 is a top view diagram of the display panel according to the first embodiment the present disclosure, and FIG. 4 is an equivalent circuit diagram of the display panel according to the first embodiment of the present disclosure. As shown in FIG. 1, a substrate 102 having a plurality of pixel regions 101 is provided. The substrate 102 may comprise a rigid substrate or a flexible substrate e.g. a glass substrate or a plastic substrate, but not limited thereto. Then, a plurality of pixel units 112 are formed in the pixel regions 101 respectively on the substrate 102. The pixel units 112 may comprise pixel units configured to provide lights of different colors, and the pixel units 112 may be arranged in a matrix pattern so that the lights of different colors are mixed to display full-color images. Further, the pixel units 112 are electrically connected to a corresponding gate line (not show in figure) and a corresponding data line (not show in figure). The gate line and the data line of the first embodiment according to the present disclosure are crisscross arranged to form the pixel units 112, but not limited thereto. For example, the pixel units 112 may include (or equal to) first pixel units 112A and second pixel units 112B, wherein the first pixel units 112A and the second pixel units 112B are used to provide lights of different colors e.g. red light, blue light, or green light.

Subsequently, a dielectric layer 104, a plurality of driving devices DR and a plurality of switching devices SW are formed on the substrate 102. The driving devices DR and the switching devices SW are disposed in the pixel regions 101 respectively. The switching devices SW are electrically connected to the driving devices DR in the same pixel units 112A or 112B. The driving devices DR and the switching devices SW may include thin film transistor (TFT) devices, and each TFT device includes a gate electrode G, a source electrode S, a drain electrode D, agate insulating layer GI and a semiconductor layer SM. The material of the semiconductor layer SM may include silicon e.g. amorphous silicon or polycrystalline silicon, oxide semiconductor e.g. indium gallium zinc oxide (IGZO), or other suitable semiconductor materials. The material of the gate electrode G, the source electrode S and the drain electrode D may include any proper conductive material e.g. metal, alloy or metal oxide, but not limited thereto. In this embodiment, the TFT device is a top gate type TFT device which means the gate electrode G is disposed on the semiconductor layer SM, but not limited thereto. For example, the TFT device may also be a bottom gate type TFT device which means the semiconductor layer SM is disposed on the gate electrode G, or other types of TFT devices.

Thereafter, an insulating layer 106 is formed on the substrate 102. The insulating layer 106 covers the driving devices DR and the switching devices SW, and has a plurality of contact holes 107 partially exposing the driving devices DR respectively e.g. exposing the drain electrodes D of the driving devices DR respectively. The insulating layer 106 may be single-layered or multi-layered, and the material of the insulating layer 106 preferably includes inorganic material such as silicon oxide, silicon nitride, silicon oxynitride or aluminum oxide, but not limited thereto. The material of the insulating layer 106 may also be other suitable inorganic material, organic material or organic/inorganic hybrid material.

Then, a pixel defining layer 108 is formed on the insulating layer 106. The pixel defining layer 108 has a plurality of openings 109 respectively disposed in the pixel regions 101. The material of the pixel defining layer 108 preferably includes organic material e.g. photoresist, benzocyclobutene (BCB), polymethylmethacrylate (PMMA), polyoxymethylene (POM), polybutylene terephthalate (PBT), polycaprolactone (PCL), polyethylene terephthalate (PET), polycarbonate (PC), polyester, polyethylene (PE), polyaryletherketone (PEEK), polylactic acid (PLA), polypropylene (PP), polystyrene (PS) or polyvinylidine chloride (PVDC), but not limited thereto. The material of the pixel defining layer 108 is preferably photosensitive, and thus can be patterned by exposure and development process. In addition, the pixel defining layer 108 may be single-layered or multi-layered. The material of the pixel defining layer 108 may also be other suitable inorganic material e.g. silicon oxide, silicon nitride, silicon oxynitride or aluminum oxide, organic material (e.g. the aforementioned organic materials) or organic/inorganic hybrid material.

Subsequently, a plurality of first connecting electrodes 111 are formed on the insulating layer 106 exposed by the openings 109 respectively. The first connecting electrodes 111 are respectively disposed in the pixel regions 101 and in the openings 109, and electrically connected to the driving devices DR through the contact holes 107 respectively. The material of the first connecting electrode 111 may comprise non-transparent conductive material e.g. silver (Ag), aluminum (Al), copper (Cu), magnesium (Mg) or molybdenum (Mo), transparent conductive material e.g. indium tin oxide (ITO), indium zinc oxide (IZO) or aluminum zinc oxide (AZO), a multi-layered materials of the aforementioned materials or an alloy of the aforementioned materials, but not limited thereto. Also, the material of the first connecting electrode 111 is preferably reflective conductive material, which is able to provide reflecting effect. Then, a passivation layer 110 may be optionally formed on the substrate 102 e.g. on the pixel defining layer 108. The passivation layer 110 exposes a portion of the first connecting electrode 111. The passivation layer 110 may be single-layered or multi-layered, and the material of the passivation layer 110 preferably includes inorganic material such as silicon oxide, silicon nitride, silicon oxynitride or aluminum oxide, but not limited thereto. The material of the passivation layer 110 may also be other suitable inorganic material, organic material or organic/inorganic hybrid material.

At least one bonding pad (or namely contact pad) 14 and at least one substitutive (or namely spare, or namely backup) bonding pad 14R are then formed in each pixel region 101 on the substrate 102. The bonding pads 14 and the substitutive bonding pads 14R may be formed by a patterning process e.g. photolithography and etching process, lift-off process or printing process. The bonding pad 14 and the substitutive bonding pad 14R are disposed on the corresponding first connecting electrode 111 and electrically connected to the corresponding first connecting electrode 111. In other words, the substitutive bonding pad 14R is electrically connected to the bonding pad 14 through the first connecting electrode 111 in the same pixel unit 112A or 112B. In this embodiment, the substitutive bonding pad 14R may include a first substitutive bonding pad 14R1, and a gap g exists between the bonding pad 14 and the substitutive bonding pad 14R of each of the pixel units 112. Preferably, the bonding pads 14 and the substitutive bonding pads 14R may be formed by the same patterned conductive layer, but not limited thereto. In addition, the bonding pads 14 and the substitutive bonding pads 14R may be formed simultaneously on the substrate 102, but not limited thereto. The material of the bonding pads 14 and the substitutive bonding pads 14R may be conductive adhesive or other suitable conductive material such as one of indium (In), bismuth (Bi), tin (Sn), silver (Ag), gold (Au), copper (Cu), gallium (Ga) or antimony (Sb), but not limited thereto.

As shown in FIGS. 2-3, a plurality of light-emitting devices 12 are formed on and connected to the bonding pads 14 respectively. The light-emitting devices 12 are located in the openings 109 of the pixel defining layer 108, and the first connecting electrode 111, the at least one bonding pad 14, the at least one substitutive bonding pad 14R and the at least one light-emitting device 12 of each pixel unit 112 are exposed by the opening 109 of the pixel defining layer 108. In this embodiment, the light-emitting devices 12 may comprise inorganic light-emitting diode devices. The inorganic light-emitting diode devices may be disposed in the pixel units 112 and on the first connecting electrodes 111 respectively. Each light-emitting device 12 at least includes a first electrode 122, a second electrode 124 and a light-emitting layer 130. For example, the first electrode 122 is disposed on the bonding pad 14, the second electrode 124 is disposed on the first electrode 122, and the light-emitting layer 130 is interposed between the first electrode 122 and the second electrode 124. In this embodiment, the inorganic light-emitting diode device may be a top emission type light-emitting device, but not limited thereto. The light-emitting layer 130 may comprise a plurality of stacking semiconductor layers, wherein the material of each semiconductor layer may include silicon (Si), germanium (Ge), II-VI group material e.g. zinc selenium (ZnS), III-V group material e.g. gallium nitride (GaN), aluminum nitride (AlN), indium nitride (InN) or a combination thereof. Each semiconductor layer may be doped or undoped, and the semiconductor layers may form a P-N (positive-negative) diode layer, a P-I-N (positive-intrinsic-negative) diode layer, a P-I (positive-intrinsic) diode layer, an N-I (negative-intrinsic) diode layer or other suitable diode layers. In addition, the inorganic light-emitting diode device may be a micro type inorganic light-emitting diode device i.e. a micrometer scale inorganic light-emitting diode device (μ-LED) having a dimension (length and width) less than micrometer level e.g. substantially less than 10 micrometers, but not limited thereto. The light-emitting device 12 is not limited to an inorganic light-emitting diode device, and may be an organic LED device or other types of light-emitting devices.

In this embodiment, the light-emitting devices 12 may be fabricated, and then mounted on and electrically connected to the first connecting electrodes 111, rather than formed on the first connecting electrodes 111 directly by thin film processes, but not limited thereto. For example, the light-emitting devices 12 may be formed on another substrate (not shown), clipped or sucked by micro robot, and then placed and mounted on the bonding pads 14 to electrically connect the first connecting electrodes 111. The bonding pads 14 and the substitutive bonding pads 14R are both conductive and meltable, and thus the bonding pads 14 may be melted by a thermal process and the light-emitting devices 12 can be bonded on the bonding pads 14. In addition, a conductive adhesive layer 126 may be optionally formed on the light-emitting device 12 in advance, the conductive layer 126 and the bonding pad 14 are then melted, and the conductive adhesive layer 126 is placed on the corresponding bonding pad 14. Accordingly, the light-emitting device 12 is bonded on the first connecting electrode 111 after the conductive adhesive layer 126 and the bonding pad 14 are solidified. The conductive adhesive layer 126 may be conductive glue or other suitable conductive materials. For example, the conductive material may be selected from at least one of indium (In), bismuth (Bi), tin (Sn), silver (Ag), gold (Au), copper (Cu), gallium (Ga) or antimony (Sb), but not limited thereto.

FIG. 4 is an equivalent circuit diagram of the display panel according to the first embodiment of the present disclosure. As shown in FIG. 4, the display panel of this embodiment uses a 2T1C driving mechanism, which comprises two TFT devices including a switching device SW and a driving device DR, and a storage capacitor Cst, but not limited thereto. The gate electrode G of the switching device SW is electrically connected to a gate line GL, the source electrode S is electrically connected to a data line DL, and the drain electrode D is electrically connected to the storage capacitor Cst and the gate electrode G of the driving device DR. The gate electrode G of the driving device DR is electrically connected to the drain electrode D of the switching device SW, the source electrode S is electrically connected to a power line PL, and the drain electrode D is electrically connected to the light-emitting device 12. The storage capacitor Cst is electrically connected between the power line PL and the drain electrode D of the switching device SW. The power line PL provides a voltage OVDD to an electrode (e.g. anode) of the light-emitting device 12, while the other electrode (e.g. cathode) is supplied with a voltage OVSS, wherein the voltage OVSS may be a common voltage or a ground voltage. The light-emitting device 12 of each pixel unit 112 may be supplied with the same voltage OVSS, but not limited thereto. In an alternative embodiment, the light-emitting devices 12 of different pixel units 112 may receive different voltages OVSS. The driving mechanism of the display panel is not limited, and may be 3T1C driving mechanism, 3T2C driving mechanism, 4T1C driving mechanism, 4T2C driving mechanism, 5T1C driving mechanism, 5T2C driving mechanism, 6T1C driving mechanism, 6T2C driving mechanism or other suitable driving mechanisms.

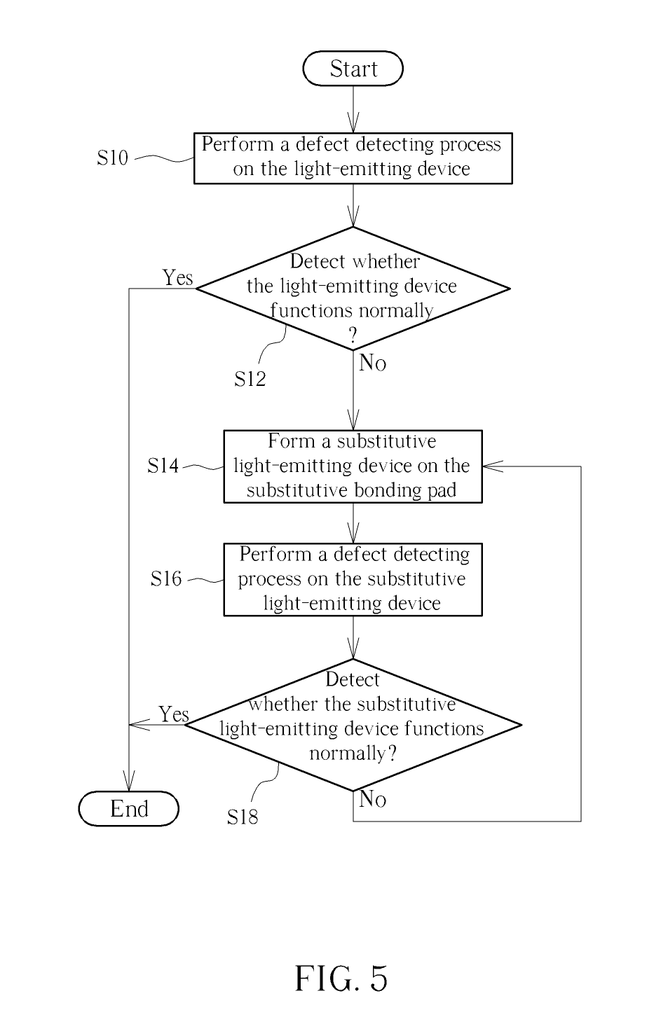

Refer to FIG. 5. FIG. 5 is a flow chart illustrating a repairing method of display panel according to an embodiment of the present disclosure. As shown in FIG. 5, the repairing method of display panel of this embodiment includes the following steps.

Step S10: Perform a defect detecting process on the light-emitting device.

Step S12: Detect whether the light-emitting device functions normally, if the light-emitting device functions normally, then terminate the repairing process and continue successive process; if the light-emitting device does not function normally, then perform Step S14.

Step S14: Form a substitutive light-emitting device on the substitutive bonding pad.

Step S16: Perform a defect detecting process on the substitutive light-emitting device.

Step S18: Detect whether the substitutive light-emitting device functions normally, if the substitutive light-emitting device functions normally, then terminate the repairing process and continue successive process; if the substitutive light-emitting device does not function normally, then perform Step S14.

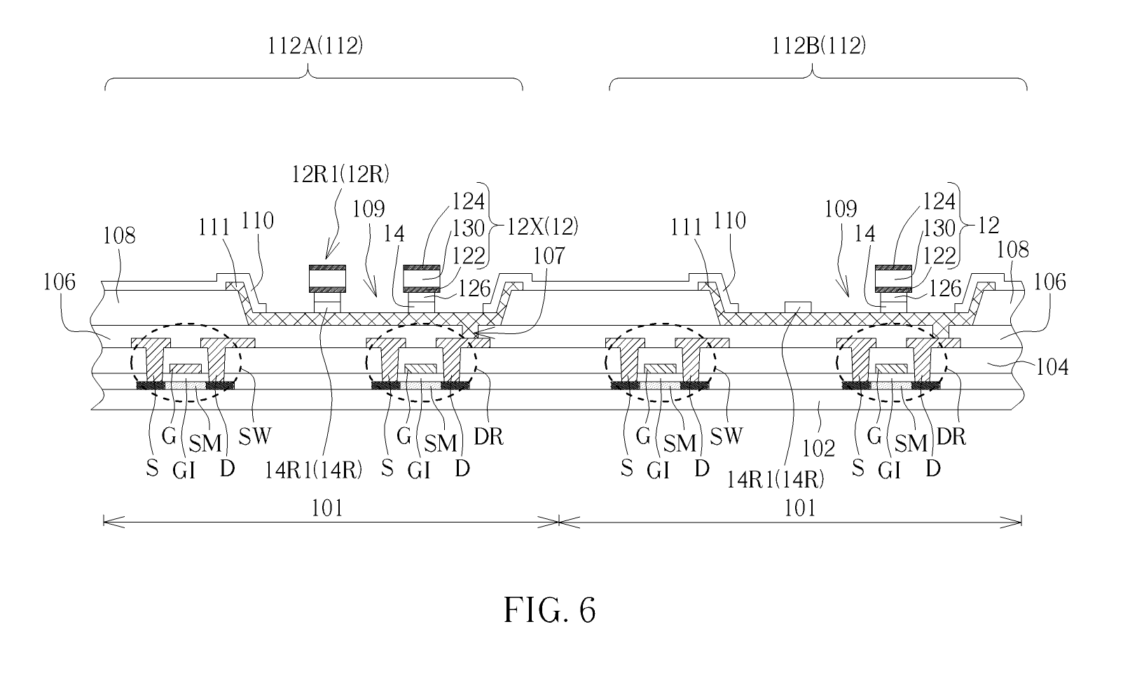

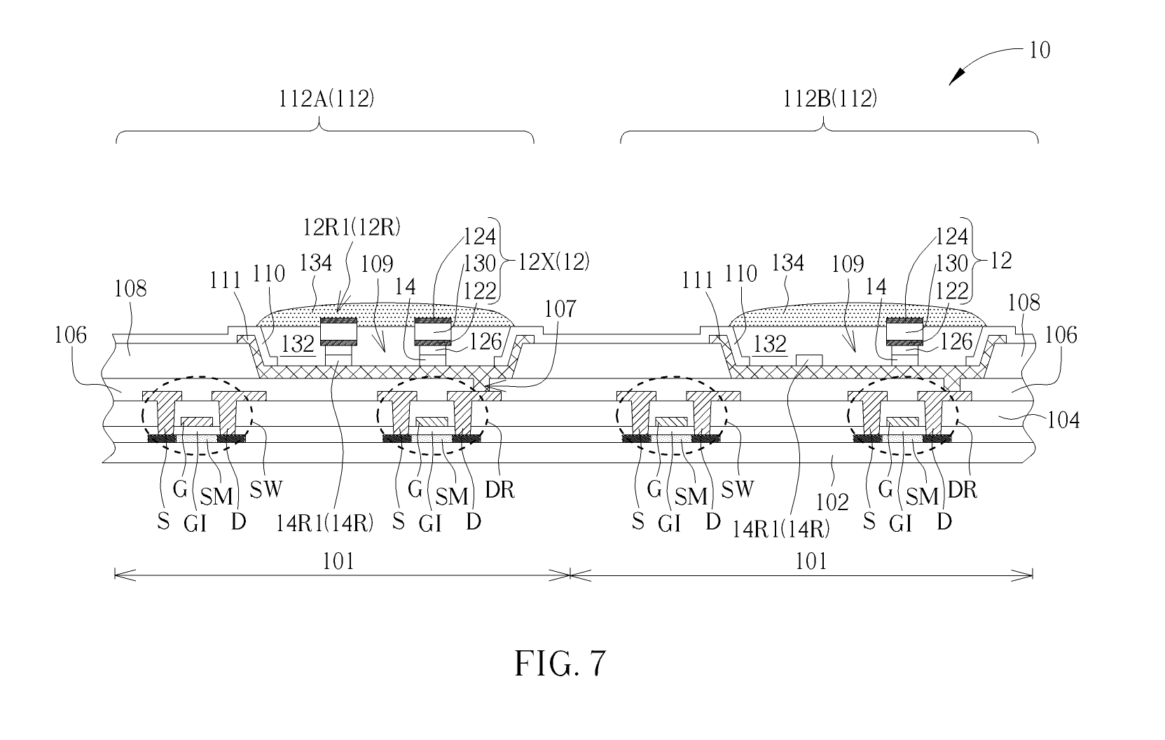

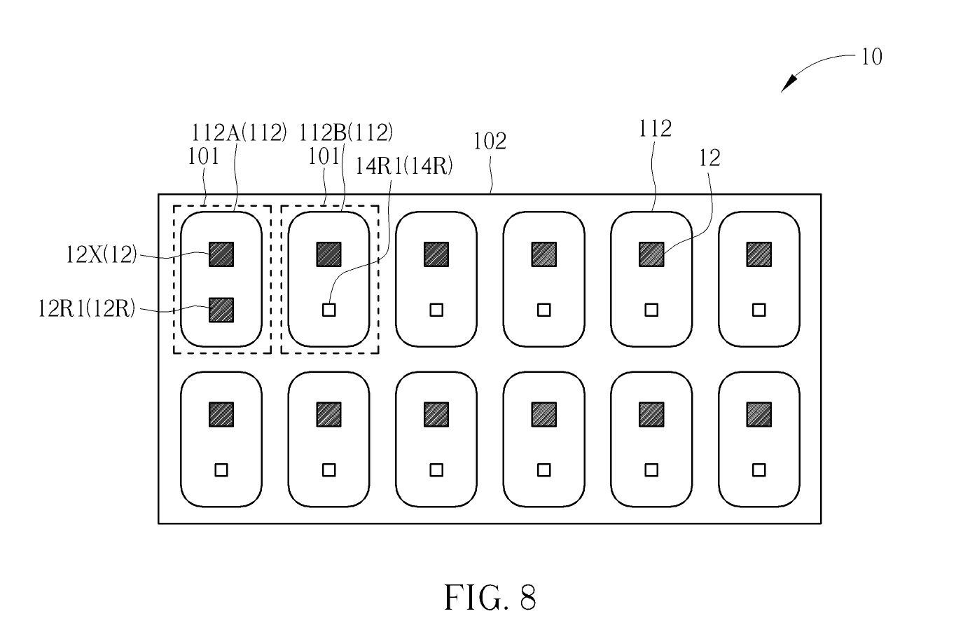

Refer to FIGS. 6-8 as well as FIG. 5. FIGS. 6-7 are schematic diagrams illustrating a repairing method of display panel according to the first embodiment of the present disclosure, and FIG. 8 is a top view diagram illustrating a repaired display panel according to the first embodiment of the present disclosure. As shown in FIG. 6, after the light-emitting devices 12 are bonded and electrically connected to the first connecting electrodes 111, the defect detecting process (Step S10) is performed to detect whether each light-emitting device 12 works normally. The defect detecting process may comprise at least one of an electrical detecting process (prober defect) or an optical detecting process. In the optical detecting process, a light source is employed to induce the light-emitting device 12 or the substitutive light-emitting device 12R to emit fluorescence, and a scan line camera is used to detect the illumination of the light-emitting device 12 or the substitutive light-emitting device 12R in a particular wavelength range so as to identify whether the light-emitting device 12 or the substitutive light-emitting device 12R is defective or not. In the electrical detecting process, a probe is employed to deliver signals that the light-emitting device 12 or the substitutive light-emitting device 12R requires so as to identify whether the light-emitting device 12 or the substitutive light-emitting device 12R is able to emit light normally or not. For example, if the detecting result shows that the light-emitting devices 12 of all pixel units 112 function normally, no repairing process is required to be done. On the other hand, if the detecting result shows that the light-emitting device 12 of a first pixel unit 112A does not function normally, the light-emitting device 12 of the first pixel unit 112A is identified as a defective light-emitting device 12X. Then, a first substitutive light-emitting device 12R1 is formed on the first substitutive bonding pad 14R1, wherein the first substitutive light-emitting device 12R1 and the light-emitting device 12 may be the same type of inorganic LED device. For example, the light-emitting device 12 and the substitutive light-emitting device 12R may be fabricated by the same process, thereby having identical specification, but not limited thereto. Subsequently, the defect detecting process (Step S16) is performed again to detect whether the first substitutive light-emitting device 12R1 functions normally or not. If the detecting result shows that the first substitutive light-emitting device 12R1 does not function normally, the first substitutive light-emitting device 12R1 may be reworked, scrapped or repaired. If the detecting result shows that the first substitutive light-emitting device 12R1 functions normally, successive process is then carried out.

As shown in FIGS. 7-8, after the defect detecting process and/or the repairing process is finished, filling layers 132 are then formed in the openings 109 of the pixel defining layer 108, wherein the filling layers 132 are respectively filled into the openings 109 of the pixel defining layer 108 to surround the light-emitting devices 12 respectively. If there is a substitutive light-emitting device 12R in the opening 109 of the pixel defining layer 108, the filling layer 132 will surround the substitutive light-emitting device 12R. Thereafter, a plurality of second connecting electrodes 134 are formed on the filling layers 132, wherein each second connecting electrode 134 is electrically connected to the second electrode 124 of the corresponding light-emitting device 12 or the second electrode 124 of the first substitutive light-emitting device 12R1. Accordingly, a display panel 10 of this embodiment is fabricated. In this embodiment, the first electrode 122 may be an anode and the second electrode 124 may be a cathode, but not limited thereto. In addition, the second connecting electrodes 134 may be connected to one another to form a continuous conductive layer. It is appreciated that the repairing method including Step S10 to Step S18 is performed prior to formation of the filling layers 132 and the second connecting electrodes 134, i.e. the first substitutive light-emitting device 12R1 is formed on the first substitutive bonding pad 14R1 prior to formation of the filling layers 132 and the second connecting electrodes 134, and thus the repairing method of the present disclosure can be performed without being obstructed by the filling layers 132 and the second connecting electrodes 134. As shown in FIGS. 7-8, in the display panel 10 of this embodiment, the first pixel unit 112A is a repaired pixel unit 112, wherein a defective light-emitting device 12X is disposed on the bonding pad 14, and a first substitutive light-emitting device 12R1 is disposed on the first substitutive bonding pad 14R1; the second pixel unit 112B is an unrepaired pixel unit 112, wherein a normal light-emitting device 12 is disposed on the bonding pad 14, and no light-emitting device is disposed on the first substitutive bonding pad 14R1. In this embodiment, the bonding pads 14 and the substitutive bonding pads 14R may be the same patterned conductive layer. That is, the bonding pads 14 and the substitutive bonding pads 14R may be simultaneously formed on the substrate 102 in advance, and no extra process is required to form the substitutive bonding pads 14R. Thus, the display panel 10 can be repaired and reworked rapidly. In addition, since the bonding pads 14 and the substitutive bonding pads 14R are the same patterned conductive layer, the bonding pads 14 and the substitutive bonding pads 14R have identical specification e.g. identical conductivity, and the first substitutive light-emitting devices 12R1 and the light-emitting devices 12R have identical specification, the brightness or/and color of light emitted by the first substitutive light-emitting devices 12R1 and the light-emitting devices 12R is uniform.

The display panel and repairing method thereof are not limited by the aforementioned embodiment, and may have other different preferred embodiments. To simplify the description, the identical components in each of the following embodiments are marked with identical symbols. For making it easier to compare the difference between the embodiments, the following description will detail the dissimilarities among different embodiments and the identical features will not be redundantly described.

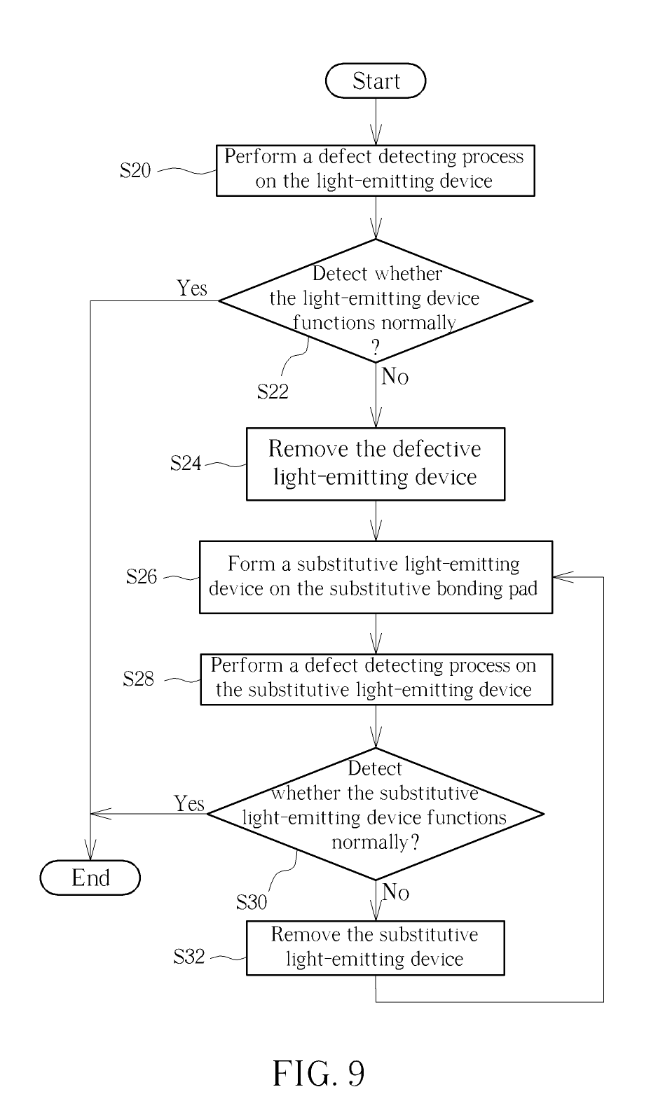

Refer to FIG. 9. FIG. 9 is a flow chart illustrating a repairing method of display panel according to another embodiment of the present disclosure. As shown in FIG. 9, the repairing method of display panel of this embodiment includes the following steps.

Step S20: Perform a defect detecting process on the light-emitting device.

Step S22: Detect whether the light-emitting device functions normally, if the light-emitting device functions normally, then terminate repairing process and continue successive process; if the light-emitting device does not function normally, then perform Step S24.

Step S24: Remove the defective light-emitting device.

Step S26: Form a substitutive light-emitting device on the substitutive bonding pad.

Step S28: Perform a defect detecting process on the substitutive light-emitting device.

Step S30: Detect whether the substitutive light-emitting device functions normally, if the substitutive light-emitting device functions normally, then terminate repairing process and continue successive process; if the substitutive light-emitting device does not function normally, then perform Step S32.

Step S32: Remove the substitutive light-emitting device, and then perform Step S26.

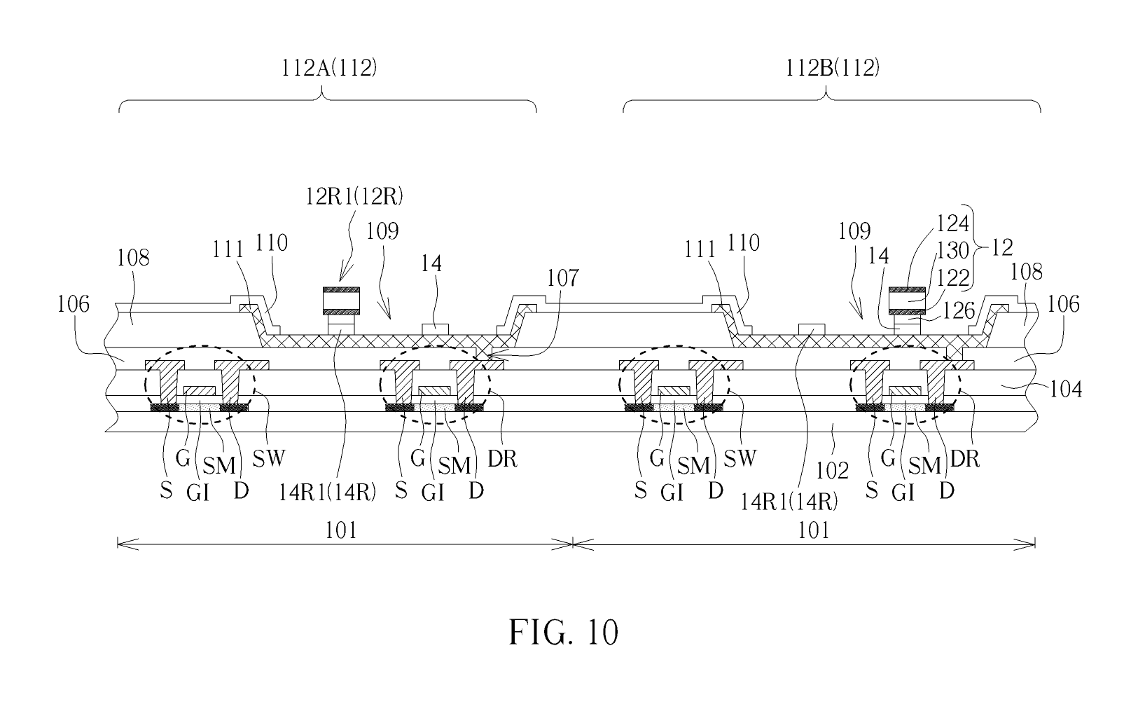

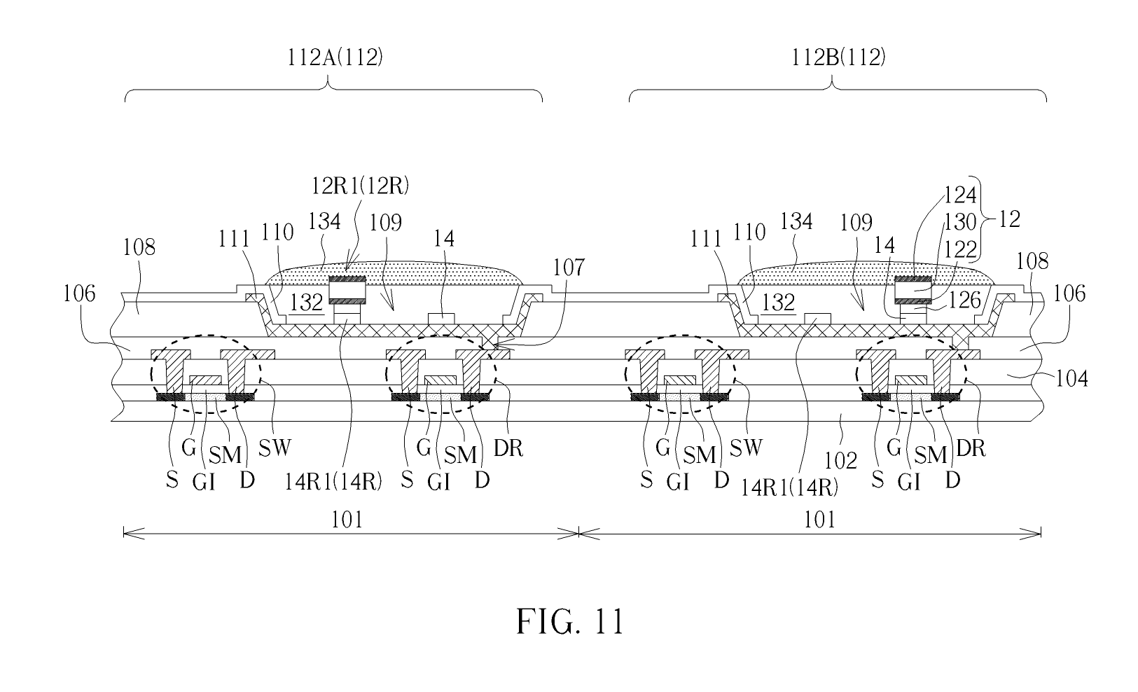

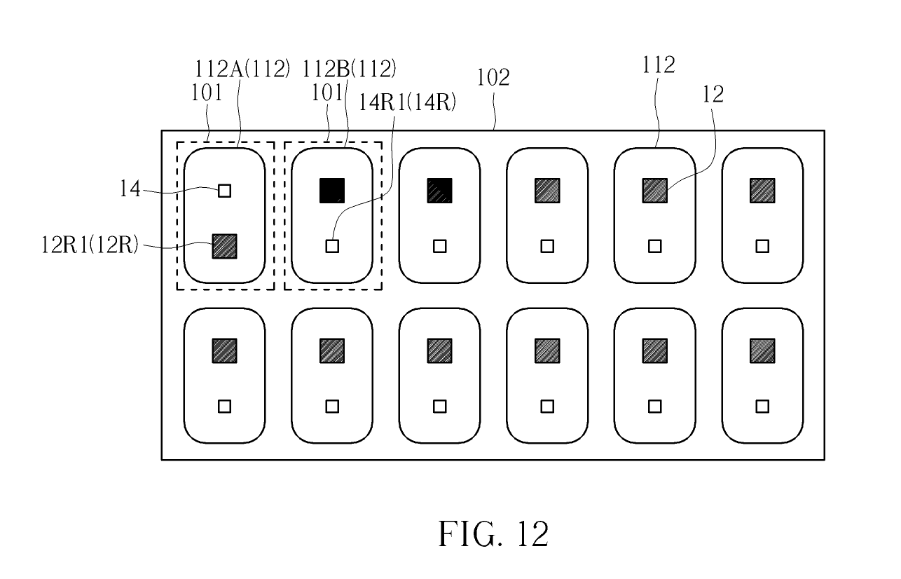

Refer to FIGS. 10-12 as well as FIG. 9. FIGS. 10-11 are schematic diagrams illustrating a repairing method of display panel according to an alternative embodiment of the first embodiment of the present disclosure, and FIG. 12 is a top view diagram illustrating a repaired display panel according to the alternative embodiment of the first embodiment of the present disclosure. As shown in FIGS. 9-12, different from the first embodiment, the repairing method of this alternative embodiment further includes removing the defective light-emitting device 12 and the defective substitutive light-emitting device 12R (Step S32) to prevent the defective light-emitting device 12 and the defective substitutive light-emitting device 12R from influencing illumination of normal substitutive light-emitting device 12R due to short-circuitry or other factors. It is appreciated that the sequence of Step S24 and Step S26 and the sequence of Step S26 and Step S32 may be exchanged.

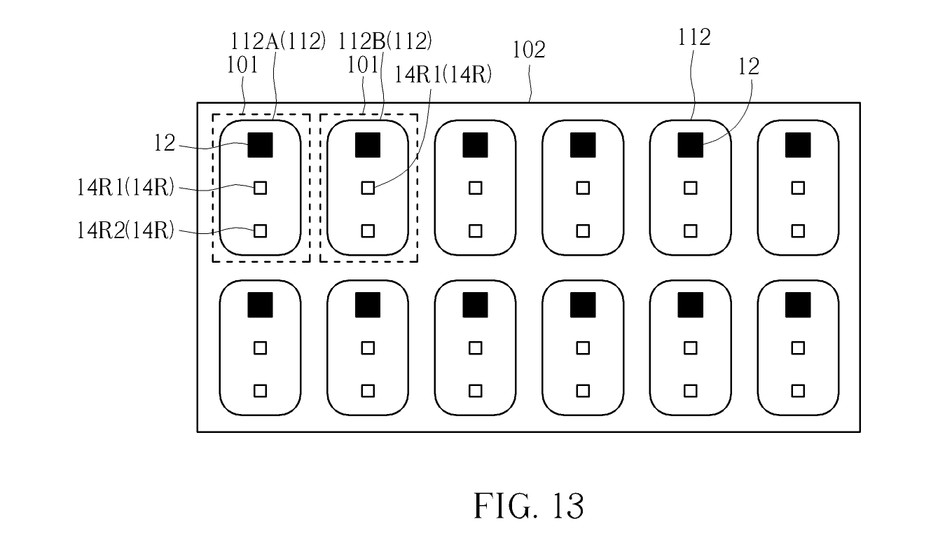

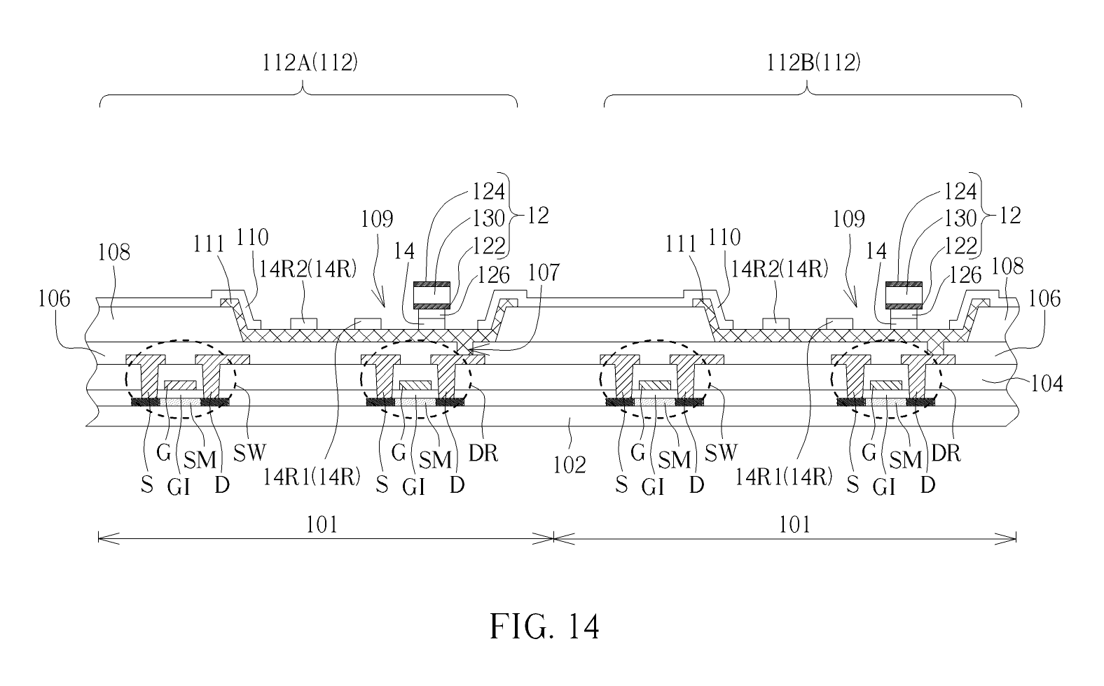

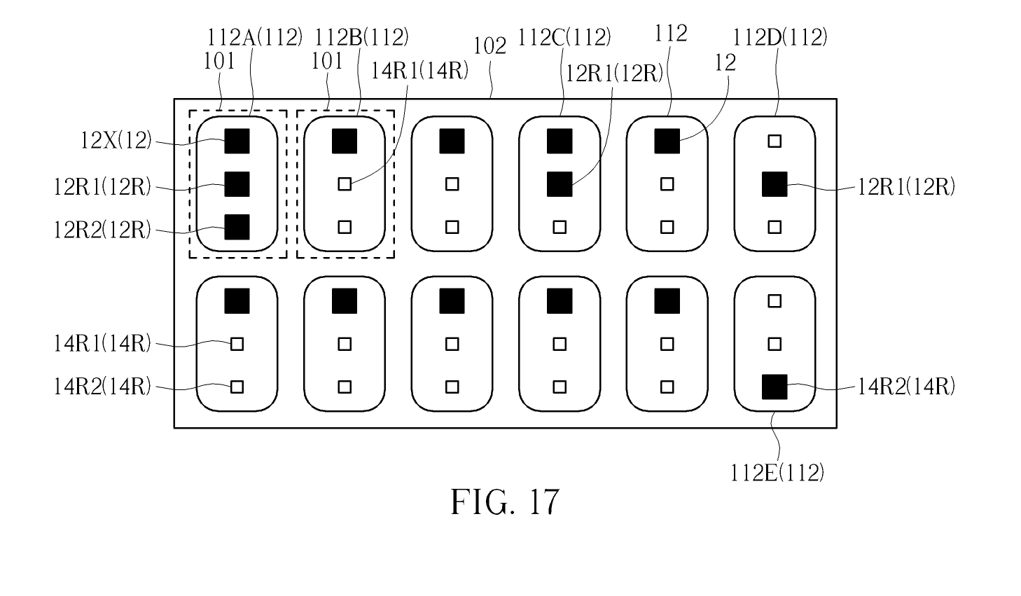

Refer to FIGS. 13-17. FIG. 13 is a top view diagram illustrating a display panel according to a second embodiment of the present disclosure, FIGS. 14-16 are schematic diagrams illustrating a repairing method of display panel according to the second embodiment of the present disclosure, and FIG. 17 is a top view diagram illustrating a repaired display panel according to the second embodiment of the present disclosure. As shown in FIGS. 13-14, each pixel unit 112 of this embodiment further includes a second substitutive bonding pad 14R2. Specifically, the substitutive bonding pads 14R of each pixel unit 112 include a first substitutive bonding pad 14R1 and a second substitutive bonding pad 14R2, wherein the first substitutive bonding pad 14R1, the second substitutive bonding pad 14R2 and the bonding pad 14 are all disposed on and electrically connected to the first connecting electrode 111. In this embodiment, the first substitutive bonding pad 14R1, the second substitutive bonding pad 14R2 and the bonding pad 14 may be arranged substantially in a row, but not limited thereto. The arrangement of the first substitutive bonding pad 14R1, the second substitutive bonding pad 14R2 and the bonding pad 14 may be modified based on different requirements. For example, the first substitutive bonding pad 14R1 and the second substitutive bonding pad 14R2 are preferably to be adjacent to the bonding pad 14. In such a case, when the first substitutive light-emitting device 12R1 or the second substitutive light-emitting device 12R2 is disposed on the first substitutive bonding pad 14R1 or the second substitutive bonding pad 14R2, the illumination of the second substitutive light-emitting device 12R2 of the first pixel unit 112A and that of the light-emitting device 12 of the second pixel unit 112B are similar, which can prevent dark point defect. Accordingly, it is difficult for the user to perceive the difference between the repaired pixel unit 112 and the unrepaired pixel unit 112.

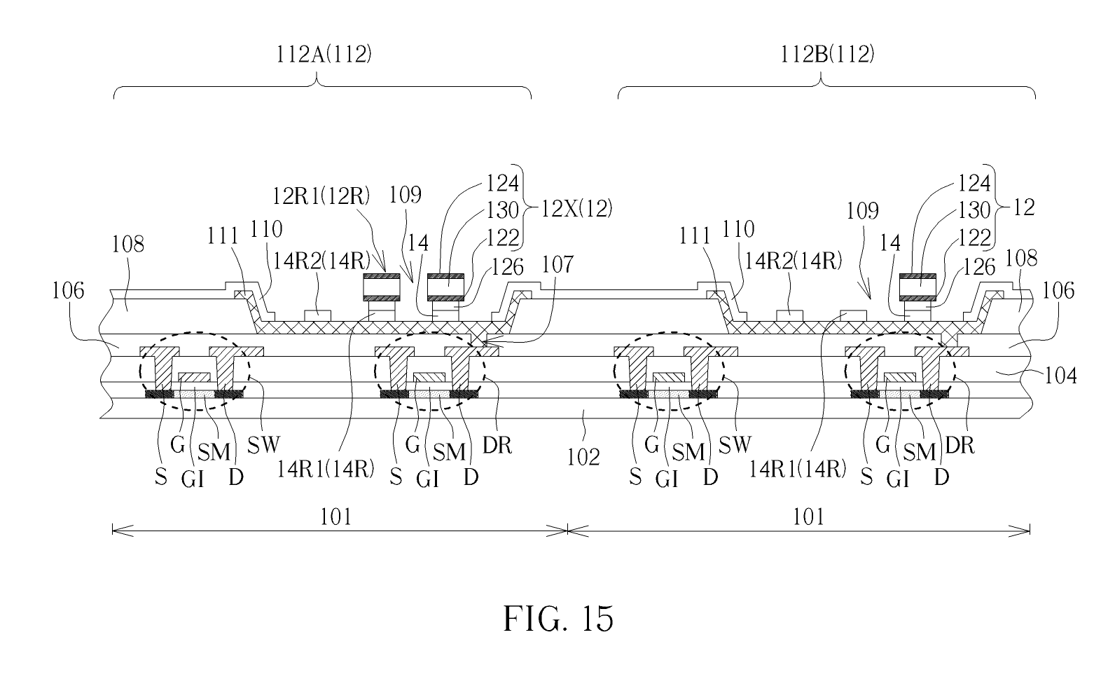

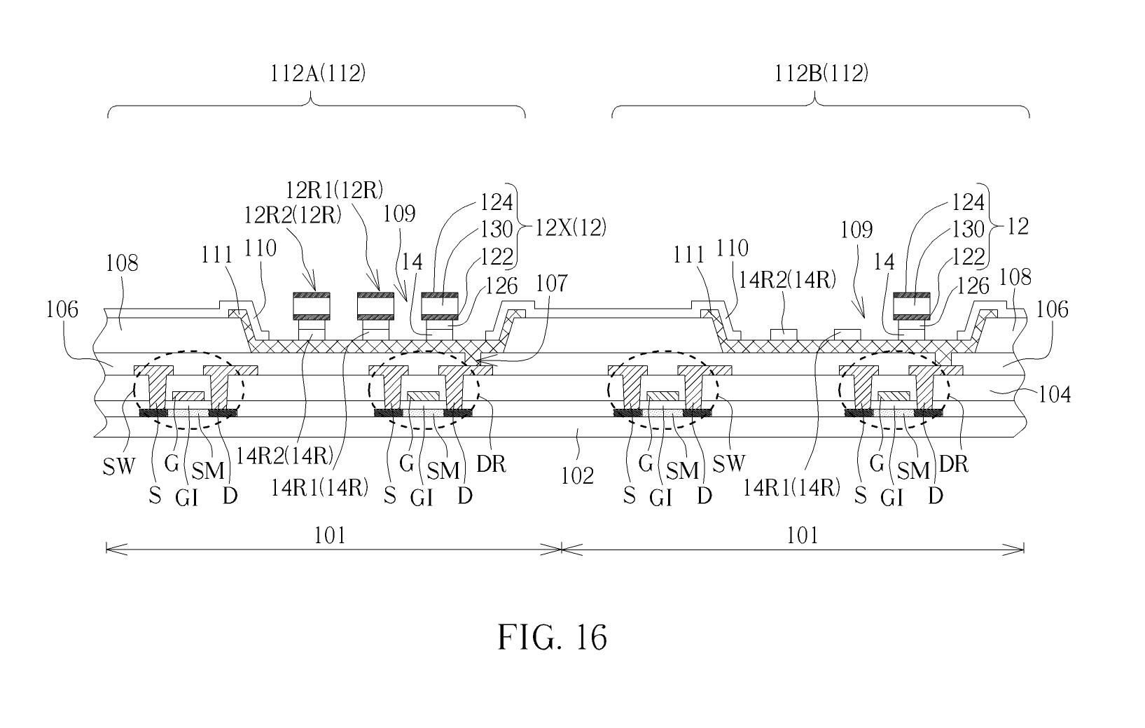

As shown in FIG. 15, a defect detecting process is performed on the light-emitting device 12 of each pixel unit 112. If the detecting result shows that the light-emitting devices 12 of all pixel units 112 function normally, no repairing process is required to be done. If the detecting result shows that the light-emitting device 12 of a first pixel unit 112A does not function normally, the light-emitting device 12 of the first pixel unit 112A is identified as a defective light-emitting device 12X. Then, a first substitutive light-emitting device 12R1 is formed on the first substitutive bonding pad 14R1, and the defective light-emitting device 12X may be optionally removed. As shown in FIGS. 16-17, a defect detecting process is performed on the first substitutive light-emitting device 12R1. If the detecting result shows that the first substitutive light-emitting device 12R1 does not function normally, a second substitutive light-emitting device 12R2 is formed on the second substitutive bonding pad 14R2, and the defective first substitutive light-emitting device 12R1 may be optionally removed. After repairing, the pixel units 112 of the display panel may have several possible arrangements. For example, the first pixel unit 112A is a repaired pixel unit 112, wherein the defective light-emitting device 12X is disposed on the bonding pad 14, the first substitutive light-emitting device 12R1, which does not function normally, is disposed on the first substitutive bonding pad 14R1, and the second substitutive light-emitting device 12R2, which functions normally, is disposed on the second substitutive bonding pad 14R2. The second pixel unit 112B is an unrepaired pixel unit 112, wherein the light-emitting device 12, which functions normally, is disposed on the bonding pad 14, and no light-emitting device is disposed on the first substitutive bonding pad 14R1 or the second substitutive bonding pad 14R2. The third pixel unit 112C is another repaired pixel unit 112, wherein the defective light-emitting device 12X is disposed on the bonding pad 14, the first substitutive light-emitting device 12R1, which functions normally, is disposed on the first substitutive bonding pad 14R1, and no light-emitting device is disposed on the second substitutive bonding pad 14R2. The fourth pixel unit 112D is still another repaired pixel unit 112, wherein no light-emitting device is disposed on the bonding pad 14, the first substitutive light-emitting device 12R1, which functions normally, is disposed on the first substitutive bonding pad 14R1, and no light-emitting device is disposed on the second substitutive bonding pad 14R2. The fifth pixel unit 112E is another repaired pixel unit 112, wherein no light-emitting device is disposed on the bonding pad 14 or the first substitutive bonding pad 14R1, and the second substitutive light-emitting device 12R2, which functions normally, is disposed on second substitutive bonding pad 14R2.

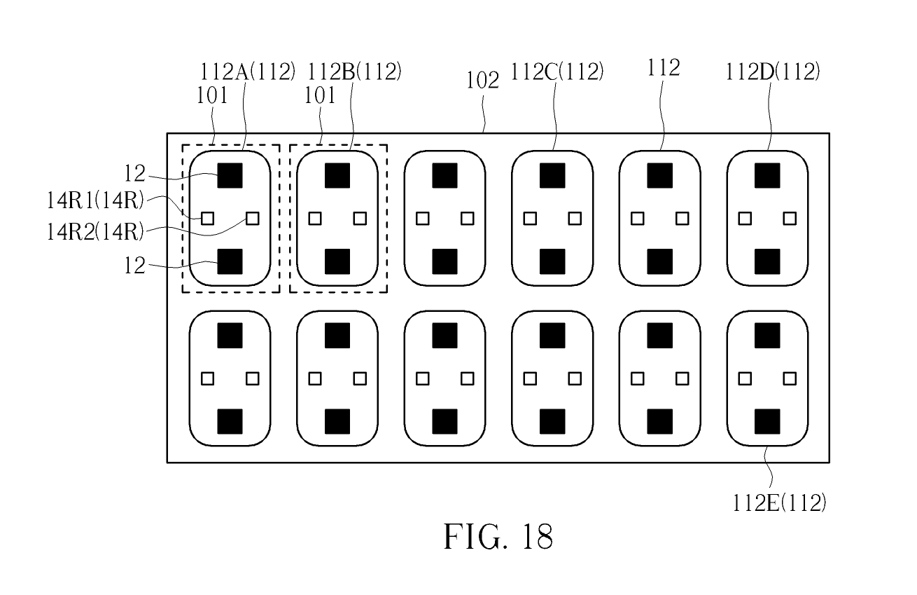

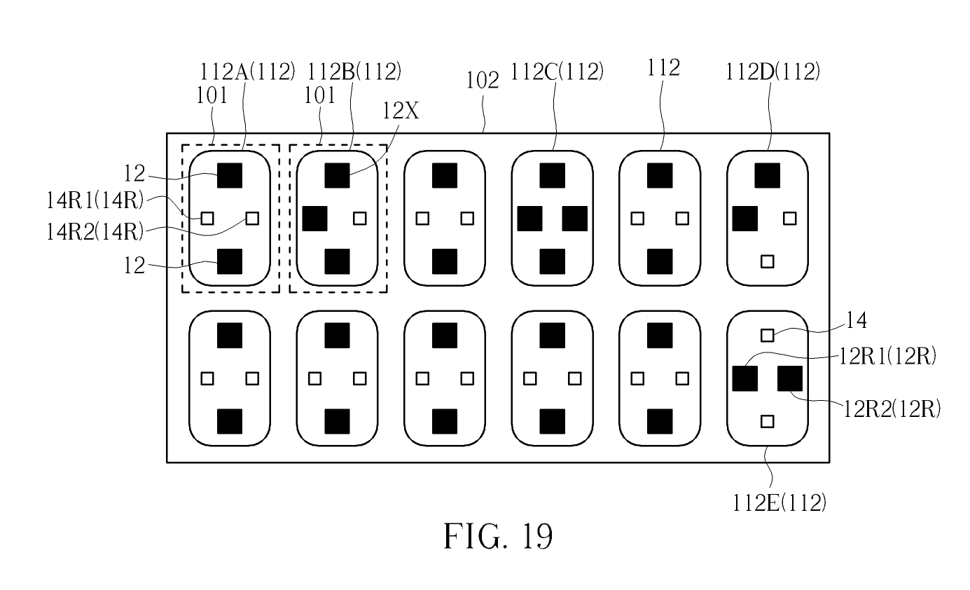

Refer to FIGS. 18-19. FIG. 18 is a top view diagram illustrating a display panel according to a third embodiment of the present disclosure, and FIG. 19 is a top view diagram illustrating a repaired display panel according to the third embodiment of the present disclosure. As shown in FIG. 18, different from the second embodiment, each pixel unit 112 of this embodiment includes a plurality of bonding pads 14. Specifically, each pixel unit 112 may include a plurality of bonding pads 14 e.g. a first bonding pad and a second bonding pad, and a plurality of substitutive bonding pads 14R e.g. a first substitutive bonding pad 14R1 and a second substitutive bonding pad 14R2. The first bonding pad, the second bonding pad, the first substitutive bonding pad 14R1 and the second substitutive bonding pad 14R2 may be arranged as a quadrangle shape e.g. a rhombus shape, but not limited thereto. The arrangement of the first bonding pad, the second bonding pad, the first substitutive bonding pad 14R1 and the second substitutive bonding pad 14R2 may be modified based on different requirements. In addition, the light-emitting devices 12 are disposed on both the first bonding pad and the second bonding pad. As shown in FIG. 19, if the light-emitting device 12 of any one pixel unit 112 is detected and found defective, the repairing method may be performed to forming a first substitutive light-emitting device 12R1 and/or a second substitutive light-emitting device 12R2 on the first substitutive bonding pad 14R1 and/or the second substitutive bonding pad 14R2, and to optionally remove the light-emitting device 12 which does not function normally. According to the spirit of the present disclosure, when any one of the foregoing embodiments is applied to the display devices, the color and/or brightness of substitutive light-emitting device 12R is substantially equal to the color and/or brightness of the defective light-emitting device 12X in the same pixel unit 112A or 112B.

In conclusion, each pixel unit of the display panel of the present disclosure includes at least one substitutive bonding pad (or namely spare bonding pad, or backup bonding pad). When a light-emitting device of a pixel unit is detected and found defective, a substitutive light-emitting device is formed on the substitutive bonding pad of the same pixel unit. Wherein the color and/or brightness of substitutive light-emitting device is substantially equal to the color and/or brightness of the defective light-emitting device in the same pixel unit. Consequently, each pixel unit includes at least one light-emitting device that can function normally. In addition, the repairing method is performed prior to formation of the filling layers and the second connecting electrodes, and thus has the advantages of easy-to-rework and simplified process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A repairing method of display panel, comprising:
providing a display panel, wherein the display panel comprises:
a substrate having a plurality of pixel regions; and
a plurality of pixel units disposed on the substrate and respectively located in the pixel regions, wherein each of the pixel units comprises:
at least one bonding pad disposed on the substrate;
at least one light-emitting device disposed on and electrically connected to the at least one bonding pad; and
at least one first substitutive bonding pad disposed on the substrate and electrically connected to the at least one bonding pad;
performing a defect detecting process to detect whether the light-emitting devices are defective or not; and
performing a repairing process to form a first substitutive light-emitting device on the first substitutive bonding pad when a light-emitting device of a pixel unit is found defective.

2. The repairing method of display panel of claim 1, further comprising removing the defective light-emitting device.

3. The repairing method of display panel of claim 1, wherein the light-emitting devices and the first substitutive light-emitting device comprise a plurality of inorganic light-emitting diode devices.

4. The repairing method of display panel of claim 1, wherein the defect detecting process comprises at least one of an electrical detecting process or an optical detecting process.

5. The repairing method of display panel of claim 4, wherein the optical detecting process comprising:
inducing the light-emitting device or the substitutive light-emitting device to emit fluorescence; and
using a scan line camera to detect the illumination of the light-emitting device or the substitutive light-emitting device so as to identify whether the light-emitting device or the substitutive light-emitting device is defective or not.

6. The repairing method of display panel of claim 1, wherein each of the pixel units further comprises a second substitutive bonding pad disposed on the substrate and electrically connected to the at least one bonding pad, and the repairing method of display panel further comprises:
performing another defect detecting process on the first substitutive light-emitting device to detect whether the first substitutive light-emitting device of the pixel unit is defective or not; and
forming a second substitutive light-emitting device on the second substitutive bonding pad of the pixel unit when the first substitutive light-emitting device is found detective.

7. The repairing method of display panel of claim 6, further comprising removing the defective first substitutive light-emitting device.

8. A display panel, comprising:
a substrate having a plurality of pixel regions; and
a plurality of pixel units disposed on the substrate and respectively located in the pixel regions, wherein each of the pixel units comprises:
at least one bonding pad disposed on the substrate;
at least one light-emitting device disposed on and electrically connected to the at least one bonding pad; and
at least one substitutive bonding pad disposed on the substrate and electrically connected to the at least one bonding pad.

9. The display panel of claim 8, wherein the bonding pads and the substitutive bonding pads are a same patterned conductive layer, and a gap exists between the at least one bonding pad and the at least one substitutive bonding pad of each of the pixel units.

10. The display panel of claim 8, wherein the light-emitting devices comprise a plurality of inorganic light-emitting diode devices.

11. The display panel of claim 10, wherein each of the inorganic light-emitting diode devices comprises:
a first electrode disposed on the bonding pad;
a second electrode disposed on the first electrode; and
a light-emitting layer interposed between the first electrode and the second electrode.

12. The display panel of claim 11, further comprising:
a plurality of driving devices disposed on the substrate and respectively located in the pixel regions;
an insulating layer disposed on the substrate and covering the driving devices, wherein the insulating layer has a plurality of contact holes partially exposing the driving devices respectively; and
a plurality of first connecting electrodes disposed on the insulating layer and respectively located in the pixel regions, wherein the first connecting electrodes are electrically connected to the driving devices through the contact holes respectively, and the bonding pads and the substitutive bonding pads are disposed on and electrically connected to the first connecting electrodes.

13. The display panel of claim 12, further comprising a pixel defining layer disposed on the insulating layer, wherein the pixel defining layer has a plurality of openings respectively disposed in the pixel regions, and each of the openings exposes the first connecting electrode, the at least one bonding pad, the at least one substitutive bonding pad and the at least one inorganic light-emitting diode device of the corresponding pixel unit.

14. The display panel of claim 13, further comprising a plurality of filling layers and at least one second connecting electrode, wherein the filling layers are filled into the openings and surround the at least one inorganic light-emitting diode devices respectively, and the at least one second connecting electrode is disposed on the filling layers and electrically connected to the second electrodes of the light-emitting devices.

15. The display panel of claim 8, wherein the pixel units comprise at least one repaired pixel unit, and the repaired pixel unit comprises at least one substitutive light-emitting device disposed on the at least one substitutive bonding pad.

16. The display panel of claim 15, wherein the pixel units comprise at least one unrepaired pixel unit, and no light-emitting device is disposed on the at least one substitutive bonding pad of the unrepaired pixel unit.

17. The display panel of claim 15, wherein a color and/or a brightness of the at least one substitutive light-emitting device is substantially equal to a color and/or a brightness of a defective light-emitting device in the repaired pixel unit.
